(19) United States
(12) Patent Application Publication
(10) Pub. No.: US 2025/0130213 A1
(43) Pub. Date: Apr. 24, 2025

(54) ANALYTE SENSING

(71) Applicants: Tower Semiconductor Ltd., Migdal Haemek (IL); Fraunhofer Gesellschaft zur Förderung der Angewandten Forschung, München (DE)

(72) Inventors: Ruth Shima Edelstein, Migdal Haemek (IL); Dmitry Ivanov, Migdal Haemek (IL); Dmitry Veinger, Migdal Haemek (IL); Yakov Roizin, Afula (IL); Sonja Hoffmann, München (DE); Michael Henfling, München (DE); Sabine Trupp, Saalfeld (DE)

(73) Assignees: Tower Semiconductor Ltd., Migdal Haemek (IL); Fraunhofer Gesellschaft zur Förderung der Angewandten Forschung, München (DE)

(21) Appl. No.: 18/820,205

(22) Filed: Aug. 29, 2024

Related U.S. Application Data
(60) Provisional application No. 63/592,511, filed on Oct. 23, 2023.

(51) Int. Cl. G01N 31/22

(52) U.S. Cl. CPC G01N 31/227

(57) ABSTRACT

A sensing device that includes (a) an image sensor matrix that comprises a first pixel and a second pixel; wherein the first pixel is configured to generate a first detection signal indicative of a presence of a first analyte; wherein the second pixel is configured to generate a second detection signal that is indifferent to the presence of the first analyte; and (b) a processing circuit that is configured to determine the presence of the first analyte based on at least a relationship between the first detection signal and the second detection signal.

### BACKGROUND OF THE INVENTION

Many application may benefit from sensing fluid within an environment.

Various sensors are susceptible to environmental conditions (such as temperature changes), and to variations in the manufacturing process of the sensors.

There is a growing need to provide an accurate and robust sensing unit.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of a sensing device;

FIGS. 2 and 3 illustrate examples of an image sensor matrix and related elements 20;

FIG. 4 illustrates an example of an image sensor matrix and related elements;

FIG. 5 illustrates an example of a matrix of sensing elements or pixels such as first pixels and second pixels, and a heater;

FIG. 6 illustrates an example of first and second pixels, and various optical elements that precede; and

FIG. 7 illustrates an example of a front end pixels and backend pixels.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF THE PREFERRED EMBODIMENTS

There is provided a sensing unit that is robust and accurate. The sensing unit includes a processing circuit and an image sensor matrix.

The image sensor matrix includes one or more pairs of pixels. Each pair of pixels includes a first pixel and a second pixel. The first pixel is configured to generate a first detection signal indicative of a presence of a first analyte. The second pixel is configured to generate a second detection signal that is indifferent to the presence of the first analyte.

The processing circuit that is configured to determine the presence of the first analyte based on at least a relationship between the first detection signal and the second detection signal. This relationship is also referred to as intra-pair relationship.

According to an embodiment, the processing circuit may include a differential circuit that calculates the difference between the first detection signal and the second detection signal.

According to an embodiment, at the absence of the first analyte the first detection signal substantially equals the second detection signal-thus any difference between the first detection signal and the second detection signal is contributed to the presence of the analyte.

According to an embodiment, the first pixel and the second pixels are exposed to the environment of the sensing unit. The difference between the first detection signal and the second detection signal may be virtually indifferent to the environment—the field of view (FOV) of the first pixel should be substantially equal to the FOV of the second pixel. Additionally or alternatively, any difference between the FOV of the first pixel and the FOV of the second pixel is reduced by using a diffuser or a scrambler that is upstream to the first and second pixels.

According to an embodiment a non-analyte related difference between the first detection signal and the second detection signal may be measured during a calibration process during which it is known that the analyte is not present. For example—if the analyte is a gas and the image sensor matrix is located within a gas chamber—then the non-analyte related difference may be measured when the gas chamber is empty or after the gas chamber is purified from the analyte. The calibration may be executed under different ambient conditions (for example under different temperatures) and when measurements are made these ambient conditions are measured and the appropriate non-analyte related difference may be taken into account.

According to an embodiment, during measurement, the non-analyte related difference is deducted from the difference between the first detection signal and the second detection signal—to provide an indication of a presence of the analyte.

The image sensor matrix may be a CMOS manufactured image sensor matrix or any other image sensor matrix. Image sensor matrixes can be provided in which adjacent pixels have virtually the same properties. Examples of image sensor matrixes include color image pixels of different types—such as but not limited to red green blue (RGB) image sensor matrixes—although any number of pixel types and/or any number of pixel types arrangement may be used. When using pixels of different types—a pair of pixels of first pixel and second pixels includes pixels of the same type. For example—one pair of pixels includes a pair of red pixels, while another pair of pixels includes a pair of green pixels and a further pair of pixels includes a pair of blue pixels.

Pixels of different types may differ from each other by a filtering applied by filters that precede the pixels.

Having the first detection signal indicative of a presence of a first analyte and having the second detection signal indifferent to the presence of the first gas or analyte may be obtained by introducing a difference between a first optical path that leads to the first pixel and a second optical path that leads to the second pixel.

According to an embodiment, the difference is introduced by (a) having the first pixel preceded by a first analyte sensitive element that is configured to change a value of an optical property at the presence of the first analyte, and (b) not having the second pixel preceded by any first analyte sensitive element.

According to an embodiment, the difference is introduced by (a) having the first pixel preceded by a first polymer element that is doped with a first analyte sensitive material that is configured to change a value of an optical property at the presence of the first analyte, and (b) having the second pixel preceded by second polymer element that is insensitive to the presence of the first analyte.

According to an embodiment, the first pixel is adjacent to the second pixel—for example may be the neighbor of the second pixel.

According to an embodiment, the first analyte is NH₃.
a. The second pixel is preceded by Sudan orange color elements.
b. The first analyte sensitive element includes a color element that is Bromphenol blue or a color element that is Bromcresol green. The inventors found out that the sensitivity to NH₃ (concentration of 200 PPH) of Bromphenol blue or Bromcresol green (measured as an amount of transmission change of the first analyte sensitive element when exposed to NH₃ (concentration of 200 PPH) exceeds by a factor of more than 20 the sensitivity of Bromcresol purple or Bromthymol blue. The inventors also found out that color elements of Bromphenol blue can be used to sense NH₃ at concentrations of 0.2 PPH to 200 PPH, and that color elements of Bromphenol blue are more sensitive than color elements of Bromcresol green.

The following table illustrates the sensitivity of color elements (may be color dots or any colored pattern) to NH₃ at 25° C. and 50% r.H.

| NH₃ | Relative transmission change (%) | | | |
|---|---|---|---|---|
| concentration | Bromphenol | Bromcresol | Bromcresol | Bromthymol |
| [PPM] | blue | green | purple | blue |
| 0.2 | 1.04 ± 0.18 | 0.52 ± 0.07 | | |
| 2 | 7.73 ± 0.32 | 4.2 ± 0.18 | | |
| 20 | 29.9 ± 0.17 | 18.2 ± 0.09 | 0.59 ± 0.07 | |
| 200 | 70 ± 0.13 | 56.1 ± 0.21 | 6.22 ± 0.07 | 2.04 ± 0.08 |

According to an embodiment, there may be multiple pairs of pixels, each pair includes a first pixel and a second pixel—to be used for detecting the first analyte.

According to an embodiment—the image sensor matrix is used for detecting more than a single analyte—and there are different pairs of pixels that are used for detecting different analytes.

According to an embodiment, the image sensor matrix further includes one or more pairs of pixels, each pair of pixels includes a third pixel and a fourth pixel. The third pixel is configured to generate a third detection signal indicative of a presence of a second analyte that differs from the first analyte. The fourth pixel is configured to generate a fourth detection signal that is indifferent to the presence of the second analyte. The processing circuit is configured to determine the presence of the second analyte based on at least a relationship between the third detection signal and the fourth detection signal.

Any reference to the first pixel, the second pixel, the first detection signal, the second detection signal, and/or the first analyte should be applied mutatis mutandis to third pixel, the fourth pixel, the third detection signal, the fourth detection signal, and/or the second analyte. The same is applicable, mutatis mutandis, to any number of different analytes.

According to an embodiment, when there are multiple pairs of pixels dedicated for detecting the same analyte—the determining related to that analyte may take into account one or more intra-pair relationships of one or more pairs of the multiple pairs.

For example—an analyte may be detected when there is at least a predefined number of inter-pair relationships that are indicative of the presence of the analytes and/or when there is at least a predefined percentage of inter-pair relationships (of the multiple inter-pair relationships) that are indicative of the presence of the analyte.

The predefined number and/or the predefined percentage may be determined in any manner—for example based on tests, based on an estimate and the like.

The predefined number and/or the predefined percentage may be per analyte—for example different analytes may be associated with different predefined numbers and/or different predefined percentages.

According to an embodiment, a fast detection period (for example below tens of seconds) of gas may be obtained, even at the presence of a low concentration of gas, when using multiple pixels that are very small (micrometer till ten of micrometer lengths and/or widths or of minimum sizes that can be manufactured). Much larger pixels cannot exhibit such a fast detection period.

According to an embodiment, the first pixel is preceded by a first via waveguide and the second pixel is preceded by a second via waveguide. The first and second waveguides may improve the collection efficiency of radiation that reaches the first and second pixels. The first and second waveguides may be identical to each other or may differ from each other. For example—first via waveguide is a first analyte sensitive element that is configured to change a value of an optical property at the presence of the first analyte—while the second via waveguide is not a first analyte sensitive element. An example of a via waveguide is illustrated in U.S. Pat. No. 7,678,603 which is incorporated herein by reference.

According to an embodiment, each pixel is preceded by a via waveguide defined in the dielectric layers disposed over the pixel, where each via waveguide includes a relatively large light concentrator formed over the metal lines of the metallization layer, and a relatively narrow lower section extending between the light concentrator and the pixel through a space separating the metal lines. Via waveguides that precede the first pixels include first analyte sensitive elements, while via waveguides that precede the second pixels do not include a first analyte sensitive element. The vias may fill openings.

According to an embodiment, the openings have a wider upper part in the form of a bathtub and a lower narrower part. The openings are formed above the first and second pixels. The openings that precede the first pixels include first analyte sensitive elements, while via large openings that precede the second pixels do not include a first analyte sensitive element.

The opening may be formed by at least two stages wherein the first stage is selectively ended on an etch stop layer such as Ti, or TiN, or Si3N4 or Poly Si, and the second stage completes the opening till the required depth.

According to an embodiment, via waveguides are formed in openings that have a wider upper part in the form of a bathtub and a lower narrower part. The openings are formed above the first and second pixels. Each pixel is preceded by the via waveguide defined in the dielectric layers disposed over the pixel. Each via waveguide includes a relatively large light concentrator formed over the metal lines of the metallization layer, and a relatively narrow lower section extending between the light concentrator and the pixel through the space separating the metal lines. Via waveguides that precede the first pixels include first analyte sensitive elements, while via waveguides that precede the second pixels do not include a first analyte sensitive element.

According to an embodiment, different pairs of pixels are configured to sense (at the absence of the analyte) different colors. The pixels of the same pair are configured to sense (at the absence of the analyte) the same color.

According to an embodiment, pairs of pixels are configured to sense (at the absence of the analyte) radiation that ranges between near infrared and ultra violet (UV) radiation.

Higher quality color filtering increases the accuracy of the measurements of the intra-pair relationship.

The desired quality can be obtained by using color filters such as color layers or any other filters that their materials pass only some wavelengths. Any color filter configuration can be applied—for example Bayer, RGB-Emerald, Red-Yellow-Yellow-Magenta, Cyan-Yellow-Yellow-Magenta, Cyan-Yellow-Green-Magenta, Red-Greew-Blue-White, X-trans, Quad Bayer, Red-Yellow-Yellow-Blue quad Bayer, nine blue-nine red-eighteen green, RCCC, RCCB, and the like.

Yet another example of improving the quality may involve using a structural wavelength filter—having a pitch that is tailored to perform color filtering. A non-limiting example of a structural wavelength filter is illustrated in “Transmissive/Reflective structural color filters: theory and applications”, Yan Yu, Long Wen, Shichao Song and Qin Chen, Plasmonics and Nanoparticles, Volume 2014, Article ID 212637, which is incorporated herein by reference.

According to an embodiment, the sensing device includes a heating unit that is in thermal communication with the first pixel and with the second pixel. The heating unit is configured to heat the first pixel and the second pixel-more than a single pair of pixels. The heating is performed for sensor regeneration-after which the sensor may perform new measurements.

According to an embodiment, the heater may be arranged as a grid around pixels areas.

According to an embodiment, the heater may be arranged as a grid of metal on a backside illuminated sensor that is also used to prevent cross talk between adjacent pixels but may be used for heating and sensor material regeneration.

According to an embodiment, the heater is formed by one of the following methods: resistor in substrate made by ion implant or other doping method, resistor in poly Si layer made by ion implant or other doping method, resistor of a metal in the back end of the imager. The resistor may have a form of a snake, or a grid—or any other form.

According to an embodiment, the first pixel and the second pixel are preceded by a curved light concentrator which increases the collection effectiveness of the first and second pixels.

According to an embodiment, the first pixel and the second pixel are backside pixels and the radiation sensed by the pixels passes through the substrate before reaching the pixels. Examples of backside pixels are illustrated in U.S. Pat. No. 6,169,319 which is incorporated herein by reference.

The analyte sensitive element that is configured to change a value of an optical property at the presence of the first analyte may be printed in any manner and/or in any size and/or in any shape.

For example—the analyte sensitive element may be printed as an array, with various options of the pixels or as a periphery of the array. See, for example U.S. Pat. No. 10,210,526 which is incorporated herein by reference.

According to an embodiment, the analyte sensitive elements are deposited from a liquid source or precursors by methods such as ink printing, spray, spin coating, CVD, or ALD.

According to an embodiment, a layer that includes regions that includes analyte sensitive elements and non-sensitive regions (not including analyte sensitive elements) is formed above the pixels.

According to an embodiment, the layer is deposited from a liquid source or precursors by methods such as ink printing, spray, spin coating, CVD, or ALD.

According to an embodiment, the analyte sensitive element is configured to sense an analyte selected out of a specific gas, a specific vapor, specific organic or inorganic compounds, specific polymers, specific metal salts, specific nanoparticles, or specific composites.

According to an embodiment, the sensing device includes additives such as support materials, binding agents or stabilizers, including polymers metal salts can be added to the reference materials to improve their stability.

According to an embodiment, regions that includes analyte sensitive elements and non-sensitive region are in the form of dots of various sizes or merged dots or and all other possible arrangements.

According to an embodiment, signal of sensors intended for sensing of a certain gas are processed in order to account for cross sensitivity for different gases.

According to an embodiment, the processing is performed using one or more artificial intelligence algorithms.

According to an embodiment, the gas sensing device is packaged together with a light source (LED, lamp with filters) in a fixture allowing free gas access, so that the gas is between the sensing device and the light source.

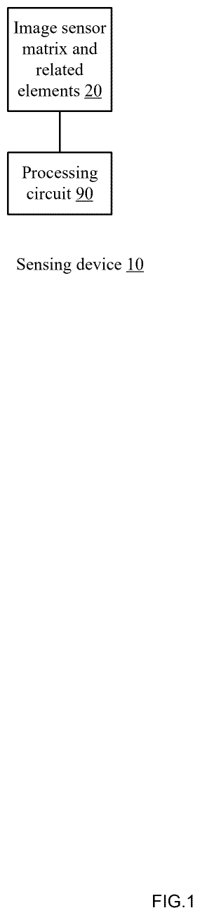

FIG. 1 illustrates an example of a sensing device 10 that includes a processing circuit 90 and image sensor matrix and related elements 20. The related elements include any component or region or element that impacts the information sensed by pixels of the image sensor matrix-such as via waveguides, color filters, mechanical filters, analyte sensitive elements, polymer elements (doped or undoped), and the like.

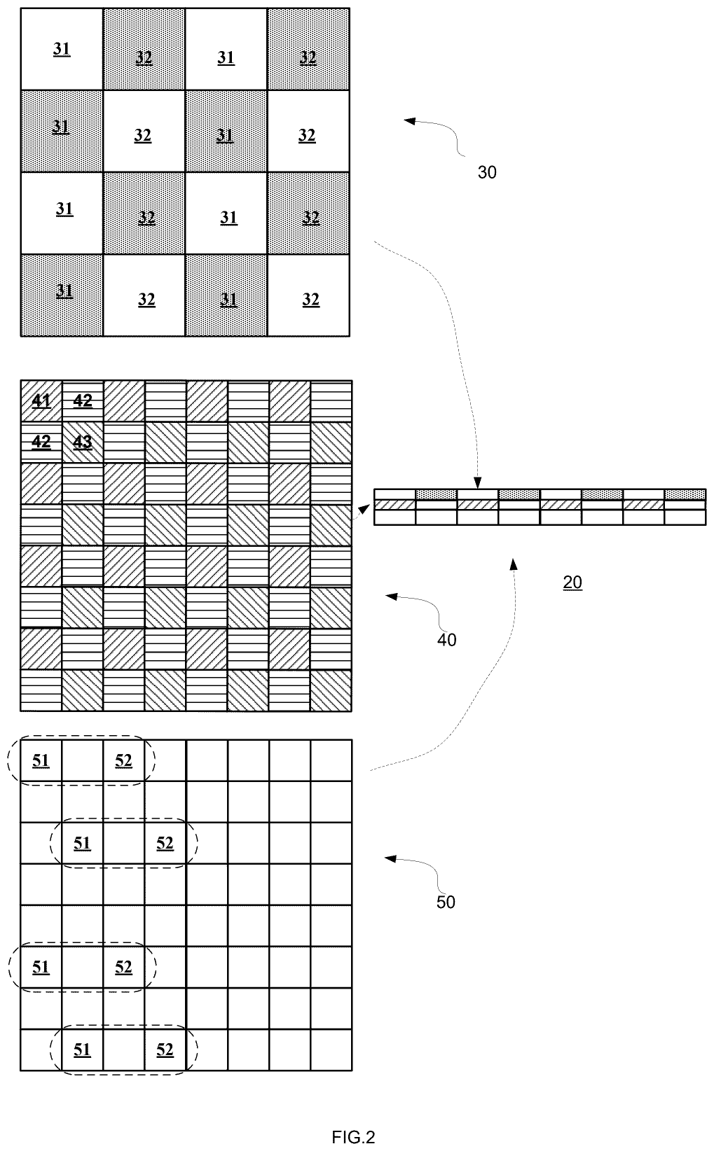

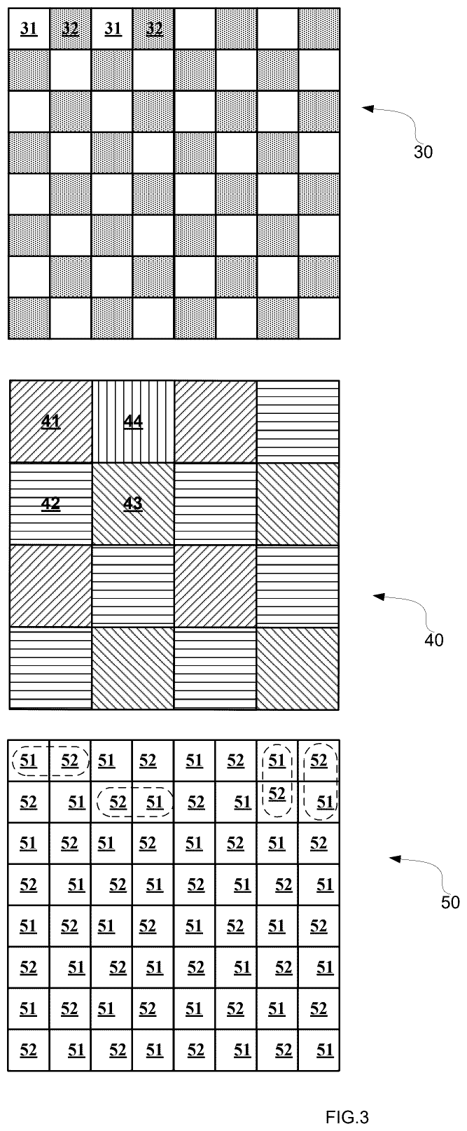

FIGS. 2 and 3 illustrate examples of an image sensor matrix (that is a color sensor matrix) and related elements 20 that includes:
a. A matrix of analyte sensitivity related regions. First regions 31 include first analyte sensitive elements and second regions 32 do not include first analyte sensitive elements.
b. A matrix of color filters 40 that includes an Bayer Red Green and Blue filters (42, 41 and 43 respectively)—although any other arrangement of color filters may be provided.
c. A matrix of sensing elements of pixels such as first pixels 51 and second pixels.

According to an embodiment, a pair that includes a first pixel and a second pixel are adapted to sense the same color at an absence of the analyte-whereas the first pixel is configured to sense the analyte when the analyte exists. This requirement dictates the relationship between the color filters 40 and the matrix of analyte sensitivity related regions.

In FIG. 2 the color filters are smaller than the analyte sensitivity related regions. In FIG. 3 the color filters are bigger than the analyte sensitivity related regions.

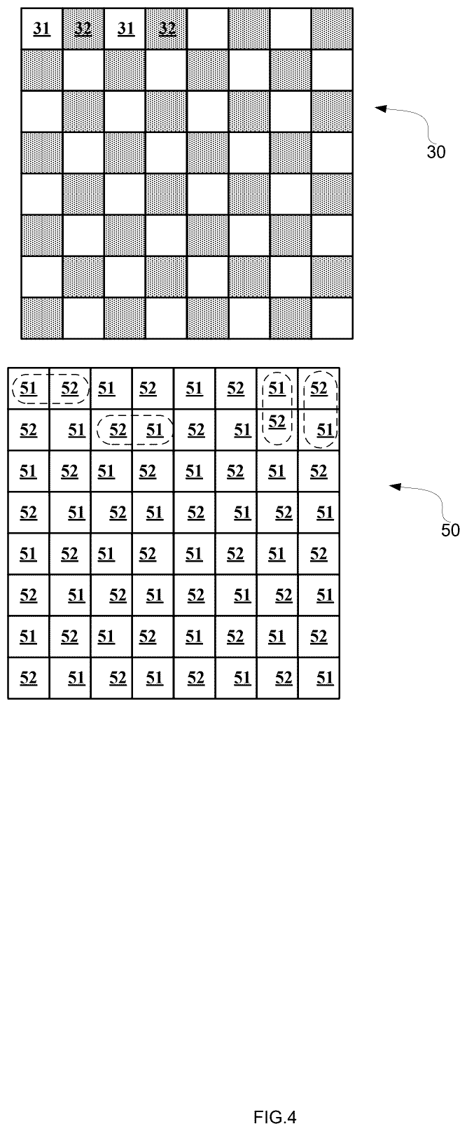

FIG. 4 illustrates an example of an image sensor matrix (that is a monochromatic sensor matrix) and related elements 20 that includes:
a. A matrix of analyte sensitivity related regions. First regions 31 include first analyte sensitive elements and second regions 32 do not include first analyte sensitive elements.
b. A matrix of sensing elements or pixels such as first pixels 51 and second pixels.

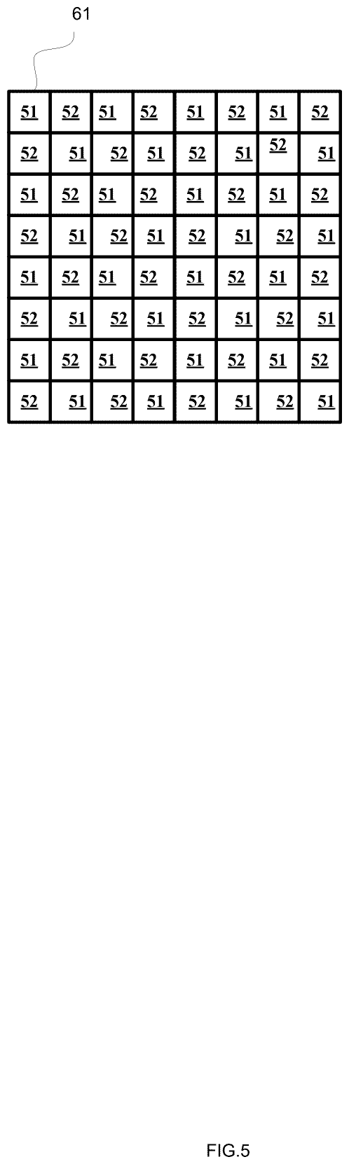

FIG. 5 illustrates an example of a matrix of sensing elements or pixels such as first pixels 51 and second pixels 52 and a heater 61 located between the pixels.

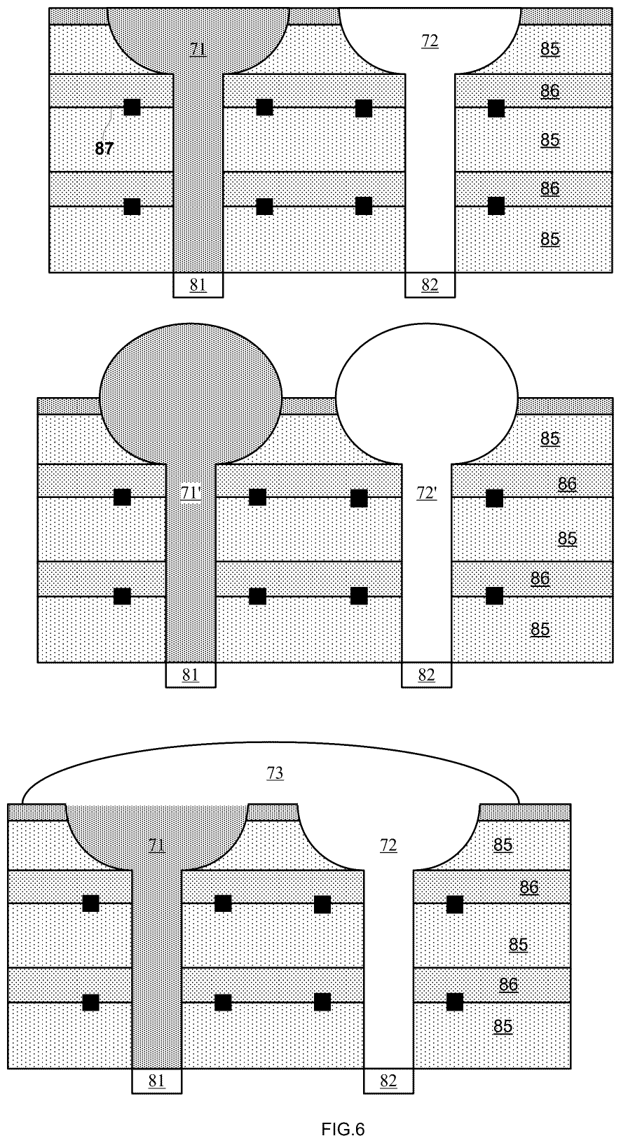

FIG. 6 illustrates an example of first pixel 81 (especially a sensing region of the first pixel), a second pixel 82 (especially a sensing region of the of a second pixel) and various optical elements that precede the first and second pixels.

The optical components include:
a. Flat first via waveguide 71 that is formed from (or includes) a first analyte sensitive material (or a first analyte sensitive element). The first via waveguide has a flat head.
b. Curved first via waveguide 71′ that is formed from (or includes) a first analyte sensitive material (or a first analyte sensitive element). The first via waveguide has a curved head that extends outside any layers (such as layers 85, 86 and metal elements 87).
c. Dome 73.
d. Flat second via waveguide 72 that is insensitive to the first analyte.
e. Curved first via waveguide 72′ that is insensitive to the first analyte.

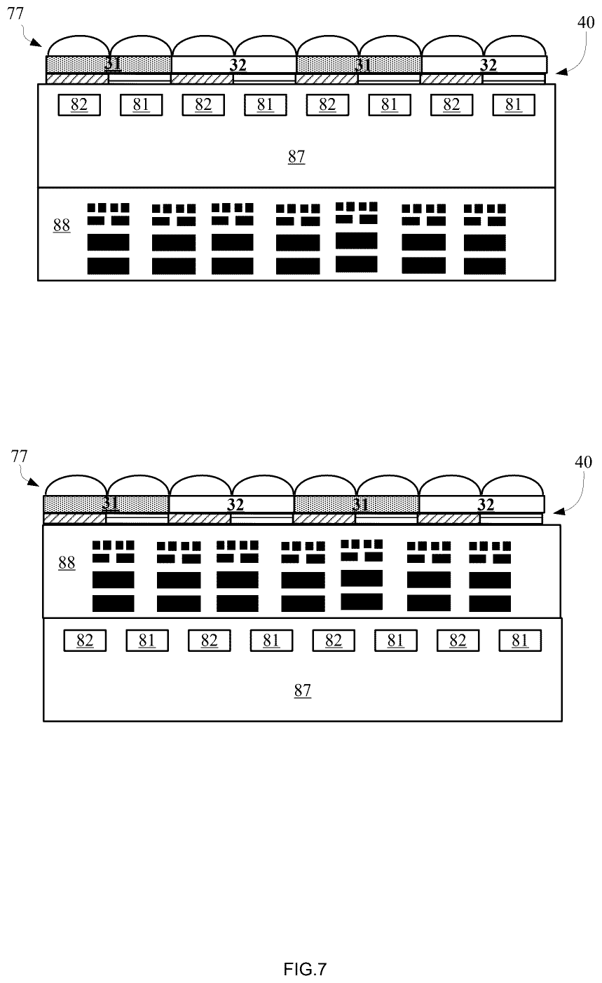

FIG. 7 illustrates an example of a front end pixels and backend pixels.

The upper example illustrates a backend configuration in which lenses 77 that are followed by a matrix of analyte sensitivity related regions (that includes first regions 51 and second regions 52), that is followed by a substrate 87 with first and second pixels 81 and 82, the substrate 87 is followed by wiring layers 88.

The lower example illustrates a frontend configuration in which lenses 77 that are followed by a matrix of analyte sensitivity related regions (that includes first regions 51 and second regions 52), that is followed by wiring layers 88, that are followed by a substrate 87 with first and second pixels 81 and 82.

In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

The term “and/or” means additionally or alternatively. For example—A and/or B—may mean only A, only B, or both A and B.

Any reference to any of the terms “comprise”, “comprises”, “comprising” “including”, “may include” and “includes” may be applied, mutatis mutandis, to any of the terms “consists”, “consisting”, “consisting essentially of”.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A sensing device, comprising:
an image sensor matrix that comprises a first pixel and a second pixel; wherein the first pixel is configured to generate a first detection signal indicative of a presence of a first analyte; wherein the second pixel is configured to generate a second detection signal that is indifferent to the presence of the first analyte; and
a processing circuit that is configured to determine the presence of the first analyte based on at least a relationship between the first detection signal and the second detection signal.

2. The sensing device according to claim 1, wherein a field of view of the first pixel substantially equals a field of view of the second pixel, wherein at the absence of the first analyte the first detection signal substantially equals the second detection signal.

3. The sensing device according to claim 1, wherein the first pixel is preceded by a first analyte sensitive element that is configured to change a value of an optical property at the presence of the first analyte; wherein the second pixel is not preceded by any first analyte sensitive element.

4. The sensing device according to claim 1, wherein the first pixel is preceded by a first polymer element that is doped with a first analyte sensitive material that is configured to change a value of an optical property at the presence of the first analyte; wherein the second pixel is preceded by second polymer element that is insensitive to the presence of the first analyte.

5. The sensing device according to claim 1, wherein the first pixel is adjacent to the second pixel.

6. The sensing device according to claim 1, wherein the first pixel and the second pixel are preceded by a diffuser.

7. The sensing device according to claim 1, wherein the image sensor matrix further comprises a third pixel and a fourth pixel; wherein the third pixel is configured to generate a third detection signal indicative of a presence of a second analyte that differs from the first analyte; wherein the fourth pixel is configured to generate a fourth detection signal that is indifferent to the presence of the second analyte; and wherein the processing circuit that is configured to determine the presence of the second analyte based on at least a relationship between the third detection signal and the fourth detection signal.

8. The sensing device according to claim 1, wherein the image sensor matrix further comprises multiple first pixels and multiple second pixels that form multiple pairs of pixels, each pair of pixels comprises a first pixel and a corresponding second pixel; and wherein the processing circuit that is configured to determine the presence of the first analyte based on at least two intra-pair relationships of at least two pairs of the multiple pairs of pixels, wherein each intra-pair relationship is a relationship between first detection signals generated by a first pixel of a pair and second detection signals generated by a corresponding second pixel of the pair.

9. The sensing device according to claim 8, wherein the processing circuit is configured to determine the presence of the first analyte based on a number of intra-pair relationships that are indicative of the presence of the first analyte.

10. The sensing device according to claim 1, wherein the first pixel is preceded by a first via waveguide and the second pixel is preceded by a second via waveguide.

11. The sensing device according to claim 10, wherein the first via waveguide is a first analyte sensitive element that is configured to change a value of an optical property at the presence of the first analyte.

12. The sensing device according to claim 1, comprising a structural wavelength filter.

13. The sensing device according to claim 1, comprising a heating unit that is in thermal communication with the first pixel and with the second pixel.

14. The sensing device according to claim 1, wherein the first pixel and the second pixel are preceded by a curved light concentrator.

15. The sensing device according to claim 1, wherein the first pixel and the second pixel are preceded by a color filter.

16. The sensing device according to claim 1, wherein the first pixel is preceded by a first analyte sensitive element that comprises color elements selected out of Bromphenol blue and Bromcresol green, and wherein the second pixel is not preceded by any first analyte sensitive element.

17. The sensing device according to claim 1, wherein the second pixel is preceded by Sudan orange color elements.

18. A method for analyte sensing, the method comprises:
generating, by a first pixel of an image sensor matrix, first detection signal indicative of a presence of a first analyte;
generating, by a second pixel of the image sensor matric, a second detection signal that is indifferent to the presence of the first analyte; and
determining, by a processing circuit, the presence of the first analyte based on at least a relationship between the first detection signal and the second detection signal.
